(19) United States
(12) Patent Application Publication
(10) Pub. No.: US 2026/0160934 A1
(43) Pub. Date: Jun. 11, 2026

(54) DISPLAY APPARATUS

(71) Applicant: LG Display Co., Ltd., Seoul (KR)

(72) Inventors: Jin Ryun KIM, Paju-si (KR); Ji Gon KIM, Paju-si (KR); Min Jin LEE, Paju-si (KR); Dae Yong KIM, Paju-si (KR); Eun Hee CHOI, Paju-si (KR)

(73) Assignee: LG Display Co., Ltd., Seoul (KR)

(21) Appl. No.: 19/402,078

(22) Filed: Nov. 26, 2025

(30) Foreign Application Priority Data
Dec. 10, 2024 (KR) 10-2024-0183052

(51) Int. Cl. F21V 8/00; G02F 1/1335; G02F 1/13357

(52) U.S. Cl. CPC G02B 6/0051; G02B 6/0065; G02F 1/133605; G02F 1/133607; G02F 1/133611

(57) ABSTRACT

Disclosed is a display apparatus having a backlight unit including a backlight light guide plate, a backlight sheet, and a backlight light source element, a liquid crystal panel located on the front surface of the backlight unit, and an optical module. The optical module includes a module light guide plate configured to receive auxiliary light from a module light source provided on the side surface of the module light guide plate and to allow the auxiliary light to pass through, a diffusion part configured to diffuse the auxiliary light toward the front surface of the module light guide plate, a selective transmission part configured to, among external light incident through a sheet hole, reflect external light in a visible wavelength band and allow external light in an infrared wavelength band to pass through, and an optical element located on the back surface of the selective transmission part.

### CROSS-REFERENCE TO RELATED APPLICATIONS

This application claims the benefit of and priority to Korean Patent Application No. 10-2024-0183052, filed on Dec. 10, 2024, the entire contents of which are incorporated herein by reference for all purposes.

### BACKGROUND

### 1. Technical Field

The present disclosure relates to a display apparatus.

### 2. Description of Related Art

In general, a display apparatus provides an image to a user. For example, the display apparatus may include a backlight unit and a liquid crystal panel that generates an image using light provided from the backlight unit. The backlight unit may include a backlight light source element located on one side surface of a backlight light guide plate. The liquid crystal panel may be located on the backlight light guide plate.

The display apparatus may include a light source module for detection of external light. For example, the light source module may include an infrared (IR) camera sensor. The light source module may overlap a partial area of the liquid crystal panel. For example, the liquid crystal panel may include an active area overlapping the backlight light guide plate and a hole area overlapping the light source module.

The hole area may be disposed within the active area. However, the hole area of the liquid crystal panel does not emit light for image implementation. Accordingly, in the display apparatus, quality of an image provided to a user and front-of-screen (FOS) quality may deteriorate due to a difference in brightness between the active area and the hole area.

The description of related art should not be considered prior art merely because it is mentioned in or associated with this section. The description of related art includes information that describes one or more aspects of the subject technology, and the description in this section does not limit the scope of the present disclosure.

### SUMMARY

One or more aspects of the present disclosure are directed to a display apparatus that substantially obviates one or more problems due to limitations and disadvantages of the related art.

An aspect of embodiments of the present disclosure is to provide a display apparatus including an optical module.

Another aspect of embodiments of the present disclosure is to improve image quality (front-of-screen (FOS) quality) characteristics of an image displayed in a hole area of a liquid crystal panel.

The aspects to be accomplished by the present disclosure are not limited to the above-mentioned aspects, and other aspects not mentioned herein will be clearly understood by those skilled in the art from the following description.

Additional advantages, aspects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these aspects and other advantages and in accordance with the purpose of the disclosure, as embodied and broadly described herein, a display apparatus includes a backlight unit including a backlight light guide plate, a backlight sheet having a sheet hole, and a backlight light source element configured to emit light to the backlight light guide plate, a liquid crystal panel located on a front surface of the backlight unit, and an optical module located on a back surface of the backlight unit and overlapped with the sheet hole, wherein the optical module includes a module light guide plate disposed on a back surface of the backlight light guide plate and overlapped with the sheet hole, the module light guide plate being configured to receive auxiliary light from a module light source located on a side surface of the module light guide plate and to allow the auxiliary light to pass through, a diffusion part disposed on a front surface of the module light guide plate and overlapped with the sheet hole, the diffusion part being configured to diffuse the auxiliary light toward a front surface of the liquid crystal panel, a selective transmission part disposed on a back surface of the module light guide plate and overlapped with the sheet hole, the selective transmission part being configured to, among external light incident through the sheet hole, reflect external light in a visible wavelength band and allow external light in an infrared wavelength band to pass through, and an optical element disposed on a back surface of the selective transmission part and overlapped with the sheet hole.

The selective transmission part may have a larger width than a width of the sheet hole and/or a smaller thickness than a thickness of the module light guide plate.

The selective transmission part may have the same width as a width of the module light guide plate.

The selective transmission part may include a dichroic layer. The selective transmission part may include a dielectric material. The selective transmission part may include at least one of silicon oxide (SiO₂), titanium oxide (TiO₂), or aluminum oxide (Al₂O₃).

The selective transmission part may have a transmittance of 5% or less in a wavelength band ranging from 400 nm (or 380 nm) to 700 nm of the external light and may have a transmittance of 90% or more in a wavelength band ranging from 900 nm to 950 nm of the external light.

The diffusion part may have a width larger than a width of the sheet hole and smaller than a width of the module light guide plate and/or a planar shape corresponding to a planar shape of the sheet hole.

The diffusion part may have a haze value in a range from 25% to 35%.

The diffusion part may be provided on the module light guide plate by directly forming unevenness including a concave shape or a convex shape on the front surface of the module light guide plate or by attaching a film having unevenness including a concave shape or a convex shape to the front surface of the module light guide plate.

The module light guide plate may include any one of glass, acrylic, polymethylmethacrylate (PMMA), and polycarbonate (PC).

The module light guide plate may include a material identical to a material of the backlight light guide plate, and/or may have a smaller thickness than a thickness of the backlight light guide plate.

The optical element may include an infrared (IR) sensor, and/or the module light source may emit the auxiliary light in the visible spectrum.

The backlight unit further may include a backlight reflector, the backlight reflector being located on the back surface of the backlight light guide plate and being configured to reflect light emitted through the back surface of the backlight light guide plate toward the liquid crystal panel.

The backlight sheet may have a laminated structure in which a diffusion sheet, a prism sheet, and a dual brightness enhancement film are laminated.

It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIGS. 1(a) and 1(b) are views for description of a display apparatus according to an embodiment of the present disclosure;

FIG. 2 is a view showing an example of a cross section taken along lines I-I′ and II-II′ in FIG. 1(b);

FIG. 3 is an enlarged view of an area K1 in FIG. 2;

FIG. 4 is a view showing an example of a cross section taken along line III-III′ in FIG. 1(b);

FIGS. 5(a) and 5(b) are views for description of an example of an optical module according to an example of the present disclosure;

FIGS. 6(a) and 6(b) are views for description of an example of transmittance of a selective transmission part shown in FIGS. 5(a) and 5(b) depending on wavelength;

FIGS. 7(a) and 7(b) are views for description of an example of a structure of a diffusion part shown in FIGS. 5(a) and 5(b);

FIGS. 8(a) to 8(d) are views for description of an example of a range of a haze value of the diffusion part shown in FIGS. 5(a) and 5(b);

FIG. 9 is a view for description of another example of the location of a module light source shown in FIGS. 5(a) and 5(b); and

FIGS. 10(a) to 10(c) are views for description of the effect of the optical module shown in FIGS. 5(a) and 5(b).

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Hereinafter, details related to the above aspects, technical configurations, and operational effects of the embodiments of the present disclosure will be clearly understood by the following detailed description with reference to the drawings, which illustrate some embodiments of the present disclosure. Here, the embodiments of the present disclosure are provided in order to allow the technical sprit of the present disclosure to be sufficiently conveyed to those skilled in the art, and thus the present disclosure may be embodied in other forms and is not limited to the embodiments described below.

In addition, the same or extremely similar elements may be designated by the same reference numerals throughout the specification. In the drawings, the lengths and thickness of layers and regions may be exaggerated for convenience. It will be understood that, when a first element is referred to as being “on” a second element, the first element may be disposed on the second element to come into contact with the second element, and a third element may be interposed between the first element and the second element.

It is understood that, although the terms “first,” “second,” “A,” “B,” “(a),” “(b),” and the like may be used herein to describe various elements (e.g., layers, films, components, electrodes, structures, transistors, sections, members, parts, regions, areas, portions, steps, operations, and/or the like), these elements should not be limited by these terms, for example, to any particular order, precedence, or number of elements. Further, these are not used to define the essence or basis of the elements. These terms are merely used to refer to one element separately from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

The expression of a first element “and/or” a second elements should be understood as any one of the first and second elements or as any or all combinations of the first and second elements. Similar interpretations apply to the use of “and/or” with three elements or with more than three elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

The terms used in the specification of the present disclosure are merely used in order to describe particular embodiments, and are not intended to limit the scope of the present disclosure. For example, an element described in the singular form is intended to include a plurality of elements unless the context clearly indicates otherwise. In one or more examples, unless expressly stated otherwise, an element may be one or more elements; and an element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. In addition, in the specification of the present disclosure, it will be further understood that the terms “comprises” and “includes” specify the presence of stated features, integers, steps, operations, elements, components, and/or combinations thereof, but do not preclude the presence or addition of one or more other features, integers, steps, operations, elements, components, and/or combinations.

Unless otherwise defined, all terms including technical and scientific terms used herein have the same meaning as commonly understood by those skilled in the art to which the present disclosure belongs. It will be further understood that terms, such as those defined in commonly used dictionaries, should be interpreted as having a meaning that is consistent with their meaning in the context of the relevant art and should not be interpreted in an idealized or overly formal sense unless explicitly defined in the specification of the present disclosure.

Further, in the specification, the front surface of an element means one surface of the element, which is located in a direction in which an image is displayed, and the back surface means the other surface of the element, which is located in the opposite direction to the front surface.

Further, in the specification, a first direction may mean either a major axis direction or a minor axis direction in the plane of a liquid crystal panel, a second direction may mean a direction intersecting the first direction in the plane of the liquid crystal panel, and a third direction may mean a thickness direction of the liquid crystal panel intersecting the first and second directions.

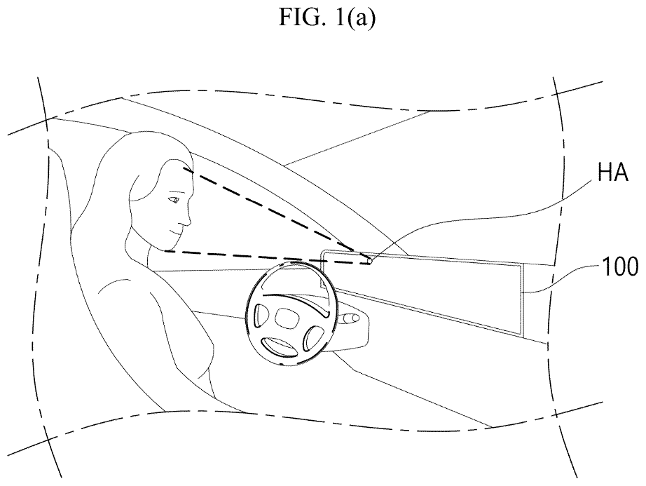

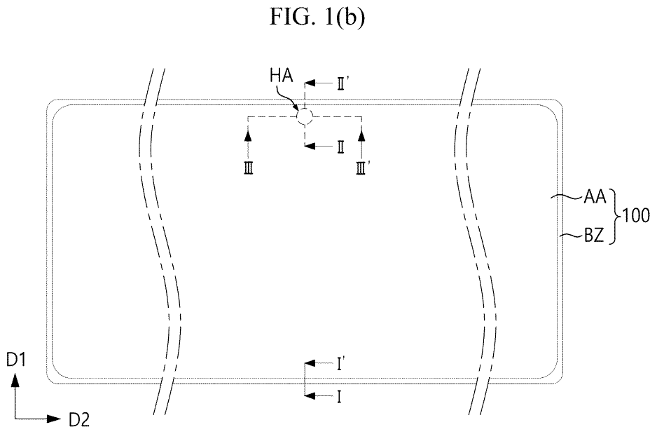

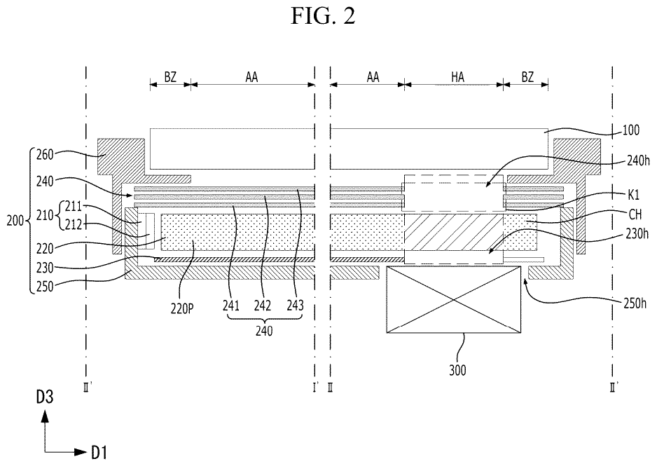

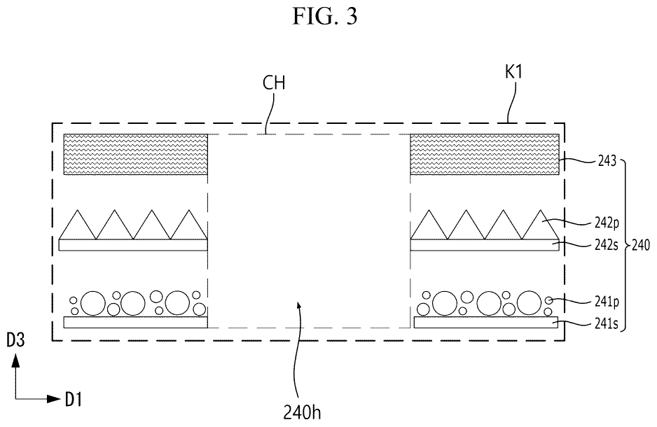

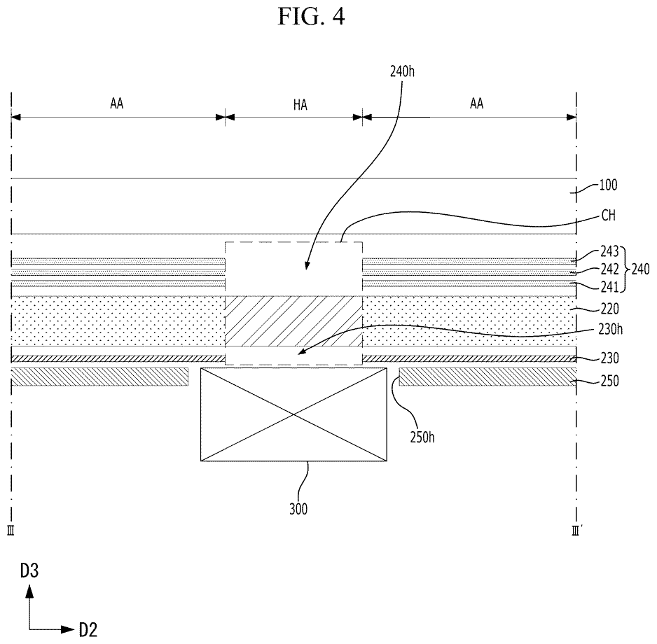

FIGS. 1(a) and 1(b) are views for description of a display apparatus according to an embodiment of the present disclosure, FIG. 2 is a view showing an example of a cross section taken along lines I-I′ and II-II′ in FIG. 1(b), FIG. 3 is an enlarged view of an area K1 in FIG. 2, and FIG. 4 is a view showing an example of a cross section taken along line III-III′ in FIG. 1(b).

A display apparatus according to an example of the present disclosure may be used as a vehicle display apparatus provided on the front surface of the driver's seat of a vehicle, as shown in FIG. 1(a), and an optical module 300 provided in the display apparatus may be used to recognize, for example, the face of a user who is a vehicle driver.

However, this is an example, and the present disclosure is not necessarily limited thereto. For example, the display apparatus of the present disclosure may also be used in a portable display apparatus such as in a notebook or a tablet, and the optical module 300 may be used to sense a target object outside the display apparatus.

Referring to FIG. 1(a) to 4, the display apparatus according to the embodiment of the present disclosure may include a liquid crystal panel 100, a backlight unit 200, and the optical module 300.

The liquid crystal panel 100 may generate an image to be provided to a user. For example, the liquid crystal panel 100 may include an active area AA having a plurality of pixel areas located therein and a bezel area BZ located outside the active area AA.

The liquid crystal panel 100 may include a liquid crystal layer overlapping the pixel areas. For example, the liquid crystal layer of the liquid crystal panel 100 may include a liquid crystal in the IPS mode or a liquid crystal in the TN mode. Various signals may be applied to the respective pixel areas through signal lines.

For example, liquid crystals located within a partial area of the liquid crystal layer overlapping each pixel area may be rotated by a vertical electric field or a horizontal electric field formed within the corresponding pixel area through signal lines. Accordingly, in the display apparatus according to the embodiment of the present disclosure, various color images may be generated by light emitted from the active area AA of the liquid crystal panel 100.

Within the active area AA, a hole area HA may be disposed at a location thereof overlapping the optical module 300. The optical module 300 may detect external light incident through the hole area HA and may sense an external target object through the hole area HA. That is, the hole area HA may function as a sensing area. The hole area HA may be an area in which a camera hole CH disposed in the backlight unit 200 is projected onto the liquid crystal panel 100.

The backlight unit 200 may supply light to the liquid crystal panel 100. For example, the backlight unit 200 may include a backlight light source element 210, a backlight light guide plate 220, a backlight reflector 230, and a backlight sheet 240.

The backlight light source element 210 may supply light to the liquid crystal panel 100 through the backlight light guide plate 220. For example, the backlight light source element 210 may be located on one side surface of the backlight light guide plate 220. The liquid crystal panel 100 may be located on the front surface of the backlight light guide plate 220.

The backlight light source element 210 may include a backlight circuit board 211 and a backlight light source 212 mounted on the backlight circuit board 211. The backlight light source 212 may be a self-luminous element capable of generating and emitting light. For example, the backlight light source 212 may include an LED.

The backlight light guide plate 220 may be located between the backlight reflector 230 and the liquid crystal panel 100, and the backlight light source element 210 may be located on the side surface of the backlight light guide plate 220. The backlight light guide plate 220 may include a transparent material and may include any one of plastic, acrylic, polymethylmethacrylate (PMMA), and polycarbonate (PC).

The backlight light guide plate 220 may receive light from the backlight light source element 210, may allow the light to pass through according to the principle of total internal reflection, and may emit, through refraction and scattering of light, the light in a front surface direction in which the liquid crystal panel 100 is located. To this end, the backlight light guide plate 220 may include a light guide plate pattern 220P for refraction and scattering of light.

For example, as shown in FIG. 2, the light guide plate pattern 220P may be located at a portion of the backlight light guide plate 220, which overlaps the active area AA, and may not be provided at a portion of the backlight light guide plate 220, which overlaps the hole area HA or the camera hole CH.

The backlight reflector 230 may be located on the back surface of the backlight light guide plate 220. The back surface of the backlight light guide plate 220 may face the front surface of the backlight reflector 230. For example, the backlight reflector 230 may include a material capable of reflecting light. For example, the backlight reflector 230 may include metal such as aluminum (Al) and silver (Ag).

Light emitted through the back surface of the backlight light guide plate 220 may be reflected toward the liquid crystal panel 100 by the backlight reflector 230. Therefore, in the display apparatus according to the embodiment of the present disclosure, the amount of light supplied to the liquid crystal panel 100 may be increased by the backlight unit 200.

The backlight reflector 230 may have a reflector hole 230h provided in a portion thereof overlapping the hole area HA and formed to be open, and the reflector hole 230h may form the camera hole CH together with a sheet hole 240h formed in the backlight sheet 240.

The backlight sheet 240 may be located between the backlight light guide plate 220 and the liquid crystal panel 100. Light supplied to the liquid crystal panel 100 through the backlight light guide plate 220 may have overall uniform brightness due to the backlight sheet 240. For example, the backlight sheet 240 may have a laminated structure in which a diffusion sheet 241, a prism sheet 242, and a dual brightness enhancement film (DBEF) 243 are laminated.

For example, as shown in FIG. 3, the diffusion sheet 241 may include diffusion particles 241p dispersed on a first base substrate 241s. The first base substrate 241s may include a transparent material. For example, the first base substrate 241s may include plastic.

The diffusion particles 241p may have various sizes. Accordingly, in the display apparatus according to the embodiment of the present disclosure, it is possible to improve uniformity of light supplied to the liquid crystal panel 100 through the backlight sheet 240. The diffusion particles 241p may be fixed on the first base substrate 241s by a transparent resin.

The prism sheet 242 may include a prism member 242p located on a second base substrate 242s. For example, the cross section of the prism member 242p may have a shape in which triangles are repeatedly arranged.

The second base substrate 242s may include a transparent material. For example, the second base substrate 242s may include plastic. The prism member 242p may include a transparent material. For example, the prism member 242p may be formed of the same material as that of the second base substrate 242s. A boundary between the second base substrate 242s and the prism member 242p may not be visually recognized. The second substrate 242s may include the same material as that of the first base substrate 241s.

The dual brightness enhancement film 243 may be configured to include a plurality of layers and may increase the amount of light that is incident on the liquid crystal panel 100 from the backlight light guide plate 220 by utilizing polarization characteristics of light, thereby improving brightness of the liquid crystal panel 100.

The dual brightness enhancement film 243 may have a function of selectively transmitting light of a specific polarization component to the liquid crystal panel 100 and reflecting light of other polarization components so as to return the light to the backlight reflector 230. The dual brightness enhancement film 243 may also be referred to as a reflective polarizer.

Light reflected by the dual brightness enhancement film 243 may be re-reflected by the backlight reflector 230 and may be incident on the dual brightness enhancement film 243. Here, the dual brightness enhancement film 243 may increase the amount of light emitted to the liquid crystal panel 100 by repeatedly performing such reflection and re-reflection of light. In this manner, brightness of the liquid crystal panel 100 may be improved. Accordingly, the dual brightness enhancement film 243 may reduce power consumption of the backlight light source element 210 and may improve energy efficiency.

FIG. 3 shows, as an example, a case in which the backlight sheet 240 includes the diffusion sheet 241, the prism sheet 242, and the dual brightness enhancement film 243, but the present disclosure is not limited thereto. The backlight sheet 240 may include other functional sheets.

Each of the diffusion sheet 241, the prism sheet 242, and the dual brightness enhancement film 243 included in the backlight sheet 240 may have the sheet hole 240h disposed in a portion thereof overlapping the hole area HA and formed to be open. The sheet hole 240h may form the camera hole CH together with the reflector hole 230h.

A cover bottom 250 may provide a space for accommodation of the backlight light source element 210, the backlight light guide plate 220, the backlight reflector 230, and the backlight sheet 240. The cover bottom 250 may include an insulating material. For example, the cover bottom 250 may include plastic. The cover bottom 250 may include a bottom surface and side walls each protruding from an edge of the bottom surface.

The backlight reflector 230 may be located between the backlight light guide plate 220 and the bottom surface of the cover bottom 250. The space formed by the bottom surface and the side walls of the cover bottom 250 may accommodate therein the backlight light source element 210, the backlight light guide plate 220, and the backlight sheet 240.

For example, the side walls of the cover bottom 250 may surround the backlight light source element 210, the backlight light guide plate 220, and the backlight sheet 240. The cover bottom 250 may be provided with a guide (not shown) that fixes the positions of the backlight light guide plate 220 and the backlight sheet 240.

The backlight unit 200 may include a middle frame 260 configured to support the liquid crystal panel 100. The middle frame 260 may be coupled to the cover bottom 250. For example, the middle frame 260 may be coupled to the outer side of the side wall of the cover bottom 250.

The cover bottom 250 may have a cover hole 250h provided in a portion thereof overlapping the hole area HA, and the optical module 300 may be located in the cover hole 250h. The size of the cover hole 250h may be formed to be larger than the size of the camera hole CH.

The backlight light source element 210 may be fixed to the side wall of the cover bottom 250. For example, the backlight light source element 210 may be attached to the side wall of the cover bottom 250 by an adhesive member. The middle frame 260 may include a mounting area extending toward a space formed between the backlight sheet 240 and the liquid crystal panel 100.

For example, the mounting area of the middle frame 260 may overlap the bezel area BZ of the liquid crystal panel 100. The active area AA of the liquid crystal panel 100 may not overlap the mounting area of the middle frame 260.

The optical module 300 may detect external light incident through the hole area HA of the liquid crystal panel 100 and the camera hole CH of the backlight unit 200. The optical module 300 may be located to overlap the hole area HA, and the hole area HA may be an area in which the camera hole CH is projected onto the liquid crystal panel 100. The optical module 300 may detect external light incident through the hole area HA and the camera hole CH to sense a target object located outside the liquid crystal panel 100.

The camera hole CH may be configured to include, for example, the sheet hole 240h and the reflector hole 230h. Here, the width of the sheet hole 240h and the width of the reflector hole 230h may be substantially the same within an error range. Therefore, the width of the sheet hole 240h and the width of the reflector hole 230h may form the width of the camera hole CH.

The optical module 300 may be fixed on the backlight unit 200. For example, the optical module 300 may be fixedly located on the cover bottom 250.

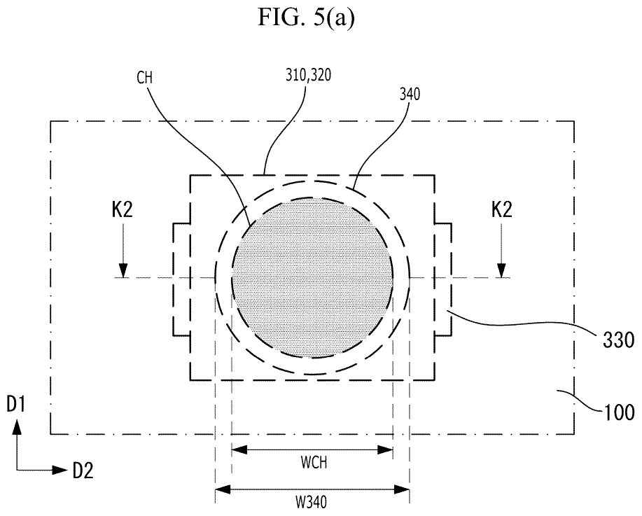

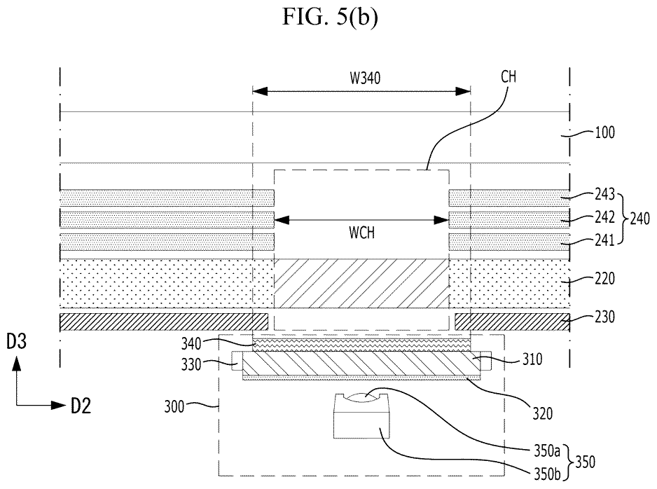

Hereinafter, the structure of the optical module 300 will be described in detail with reference to FIGS. 5(a) and 5(b) and the subsequent drawings.

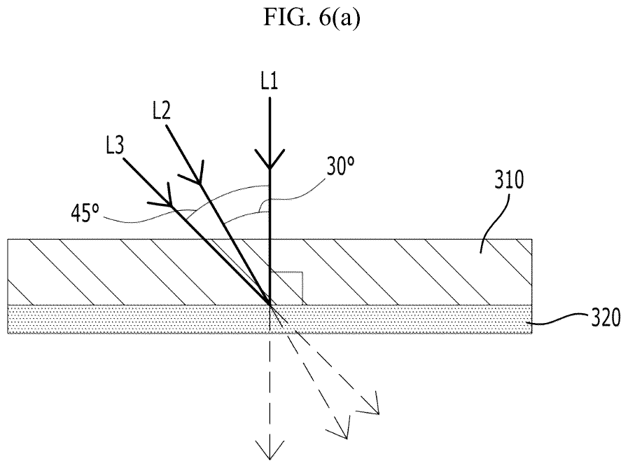

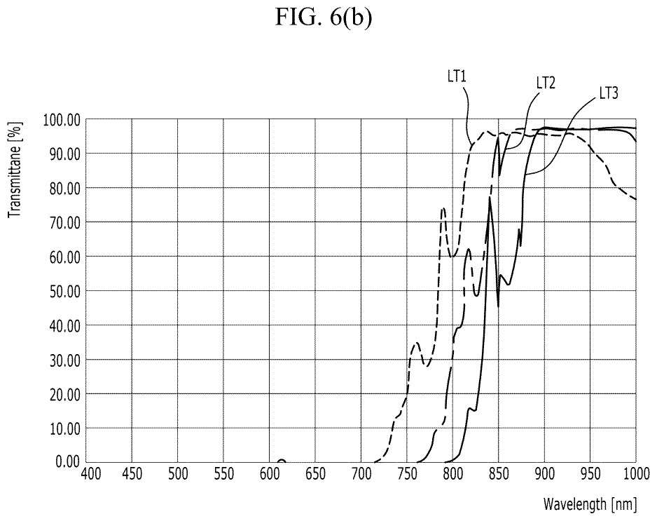

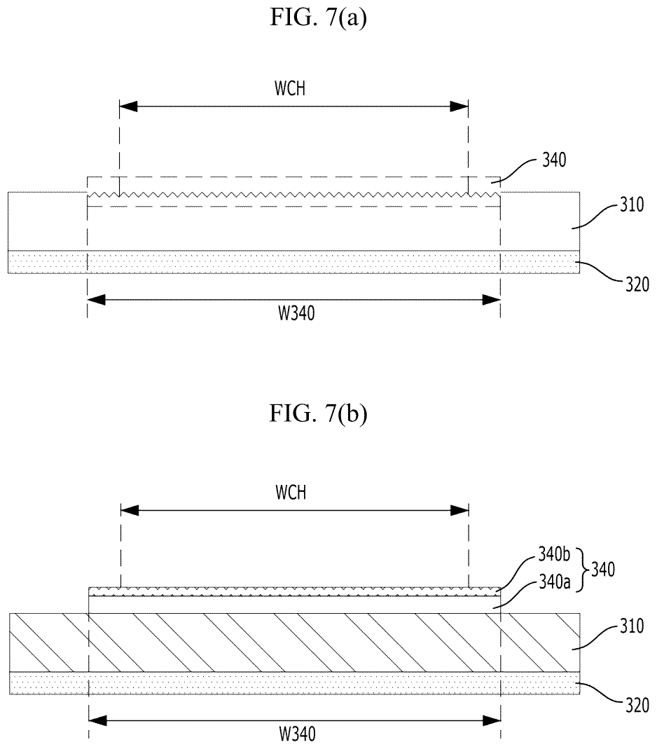

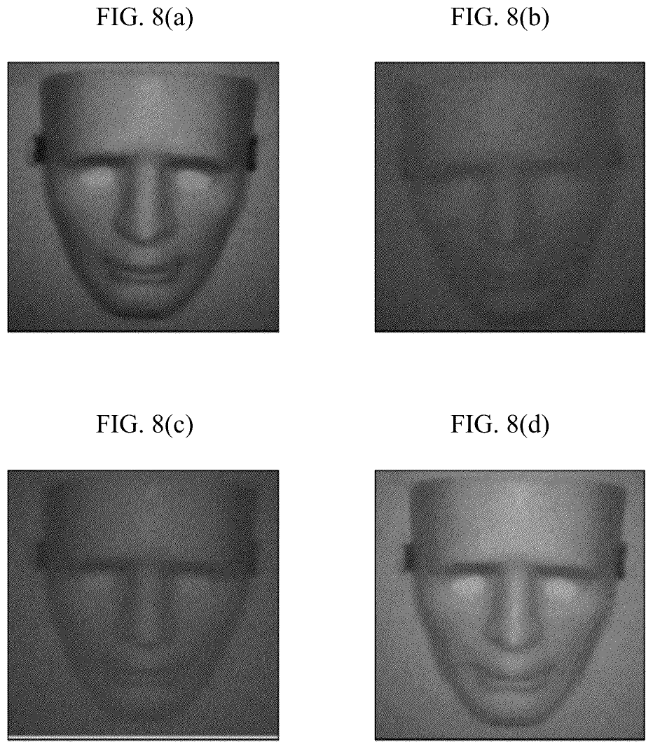

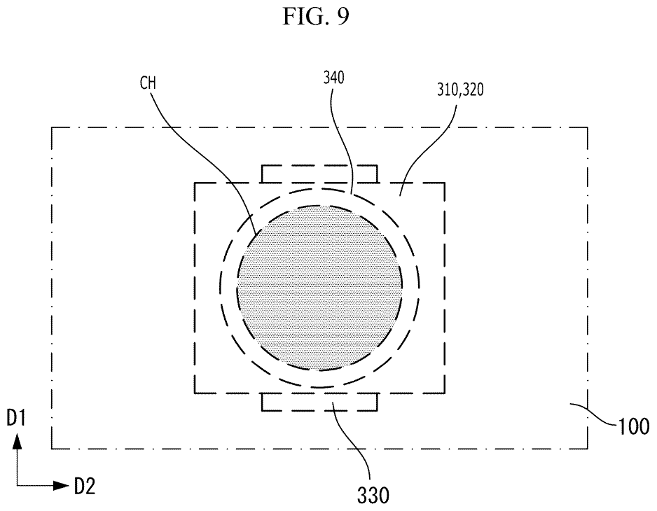

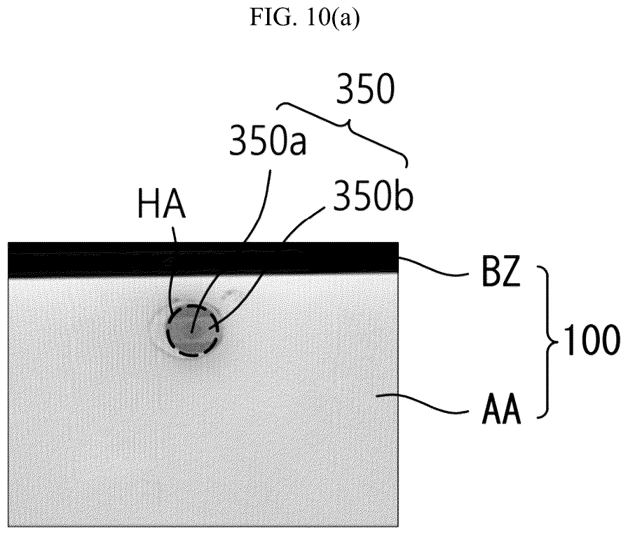

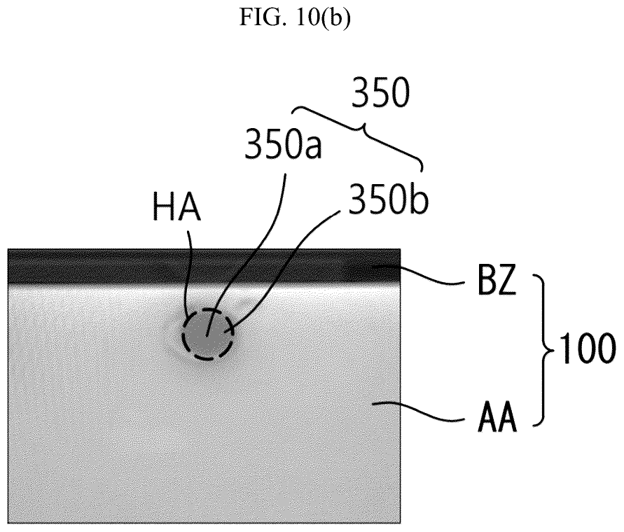

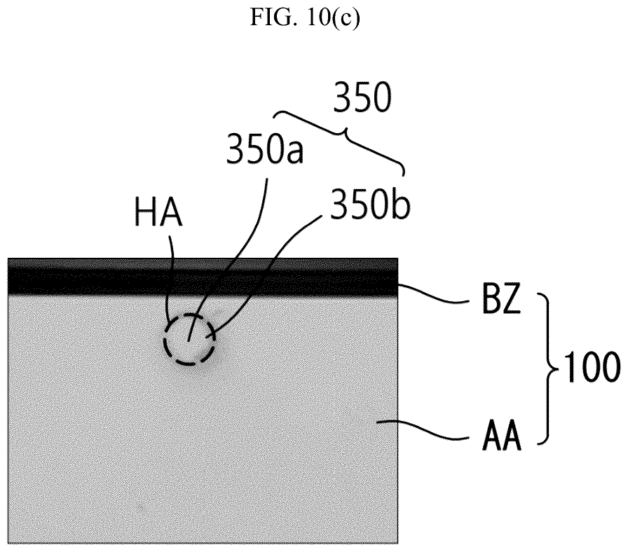

FIGS. 5(a) and 5(b) are views for description of an example of an optical module according to an example of the present disclosure, FIGS. 6(a) and 6(b) are views for description of an example of transmittance of a selective transmission part shown in FIGS. 5(a) and 5(b) depending on a wavelength, FIGS. 7(a) and 7(b) are views for description of an example of a structure of a diffusion part shown in FIGS. 5(a) and 5(b), FIGS. 8(a) to 8(d) are views for description of an example of a range of a haze value of the diffusion part shown in FIGS. 5(a) and 5(b), FIG. 9 is a view for description of another example of the location of a module light source shown in FIGS. 5(a) and 5(b), and FIGS. 10(a) to 10(c) are views for description of the effect of the optical module shown in FIGS. 5(a) and 5(b).

FIG. 5(a) is an enlarged view of the hole area HA in FIG. 1(b), and FIG. 5(b) is a view schematically showing a cross section taken along line K2-K2 in FIG. 5(a).

As shown in FIGS. 5(a) and 5(b), the optical module 300 may include a module light guide plate 310, a selective transmission part 320, a module light source 330, a diffusion part 340, and an optical element 350.

The module light guide plate 310 may be disposed on the back surface of the backlight light guide plate 220 and located to overlap the camera hole CH or the sheet hole 240h in a thickness direction D3. The module light source 330 may be located on the side surface of the module light guide plate 310 in a second direction D2. The module light guide plate 310 may receive auxiliary light from the module light source 330 located on the side surface thereof and may transmit the received light according to the principle of total internal reflection.

The module light guide plate 310 may include a transparent material and may include any one of glass, acrylic, polymethylmethacrylate (PMMA), and polycarbonate (PC). The module light guide plate 310 may include, for example, the same material as that of the backlight light guide plate 220 or a different material from that of the backlight light guide plate 220.

The thickness of the module light guide plate 310 may be smaller than the thickness of the backlight light guide plate 220. Accordingly, an increase in the thickness of the optical module 300 due to the module light guide plate 310 may be minimized.

As shown in FIGS. 5(a) and 5(b), a width of the module light guide plate 310 may be formed to be larger than a width WCH of the camera hole CH or the sheet hole 240h. Accordingly, a degree of freedom as to the location of the optical module 300 in the display apparatus may be further improved.

The selective transmission part 320 may be located on the back surface of the module light guide plate 310 in a state of overlapping the camera hole CH or the sheet hole 240h, may reflect external light in the visible wavelength band among external light incident through the camera hole CH or the sheet hole 240h, and may allow external light in the infrared wavelength band among the external light to pass through.

The selective transmission part 320 may prevent the optical element 350 from being viewed through the hole area HA of the liquid crystal panel by reflecting external light in the visible wavelength band, and external light in the infrared wavelength band may pass through the selective transmission part 320, thereby allowing the optical element 350 to reliably detect external light in the infrared wavelength band.

The selective transmission part 320 may have a transmittance of 5% or less in a wavelength band ranging from 400 nm to 700 nm, which corresponds to the visible wavelength band, among external light, and may have a transmittance of 90% or more in a wavelength band ranging from 900 nm to 950 nm, which corresponds to the infrared wavelength band, among external light.

For example, as shown in FIG. 6(a), when first external light L1 vertically enters the selective transmission part 320, as shown in FIG. 6(b), the transmittance of the selective transmission part 320 in a wavelength band ranging from 400 nm to 700 nm, which corresponds to the visible wavelength band among the first external light L1, may be 5% or less, and the transmittance of the selective transmission part 320 in a wavelength band LT1 ranging from 850 nm to 950 nm, which corresponds to the infrared wavelength band among the first external light L1, may be 90% or more.

In addition, as shown in FIG. 6(a), when second external light L2 enters the selective transmission part 320 at an incident angle of 30°, as shown in FIG. 6(b), the transmittance of the selective transmission part 320 in a wavelength band ranging from 400 nm to 770 nm among the second external light L2 may be 5% or less, and the transmittance of the selective transmission part 320 in a wavelength band LT2 ranging from 870 nm to 1000 nm among the second external light L2 may be 90% or more.

Additionally, as shown in FIG. 6(a), when third external light L3 enters the selective transmission part 320 at an incident angle of 45°, as shown in FIG. 6(b), the transmittance of the selective transmission part 320 in a wavelength band ranging from 400 nm to 800 nm among the third external light L3 may be 5% or less, and the transmittance of the selective transmission part 320 in a wavelength band LT3 ranging 900 nm to 1000 nm among the third external light L3 may be 90% or more.

As shown in FIGS. 5(a) and 5(b), the width of the selective transmission part 320 may be larger than the width WCH of the camera hole CH or the sheet hole 240h. For example, the width of the selective transmission part 320 may be formed to be substantially the same as the width of the module light guide plate 310. Accordingly, the camera hole CH on the back surface of the backlight unit 200 may be covered by the module light guide plate 310 and the selective transmission part 320. Accordingly, a degree of freedom as to the location of the optical module 300 in the display apparatus may be further improved.

The thickness of the selective transmission part 320 may be smaller than the thickness of the module light guide plate 310. As a result, an increase in the thickness of the optical module 300 due to the selective transmission part 320 may be minimized.

The selective transmission part 320 may include, for example, a dichroic layer that reflects light in the visible wavelength band and allows light in the infrared wavelength band to pass through. The dichroic layer included in the selective transmission part 320 may include a dielectric material and may include a plurality of layers having different refractive indices.

Specifically, the selective transmission part 320 may include at least one of silicon oxide (SiO₂), titanium oxide (TiO₂), or aluminum oxide (Al₂O₃). For example, the selective transmission part 320 may be formed by laminating a layer including silicon oxide (SiO₂), a layer including titanium oxide (TiO₂), and a layer including aluminum oxide (Al₂O₃).

The diffusion part 340 may be located on the front surface of the module light guide plate 310 in a state of overlapping the camera hole CH or the sheet hole 240h and may diffuse auxiliary light toward the front surface. The diffusion part 340 may refract and scatter the auxiliary light traveling inside the module light guide plate 310, thereby allowing the auxiliary light to be diffused toward the hole area HA of the liquid crystal panel through the inside of the camera hole CH.

Specifically, the auxiliary light emitted from the module light source 330 may be light in the visible spectrum. Here, the auxiliary light may be reflected by the selective transmission part 320 and may travel inside the module light guide plate 310. In this state, the auxiliary light may be scattered by the diffusion part 340 and may be diffused toward the camera hole CH.

To this end, a width W340 of the diffusion part 340 may be larger than the width WCH of the camera hole CH or the sheet hole 240h and may be smaller than the width of the module light guide plate 310. Accordingly, a degree of freedom as to the location of the diffusion part 340 in the optical module 300 may be further improved.

The planar shape of the diffusion part 340 may correspond to the planar shape of the camera hole CH or the sheet hole 240h, as shown in FIG. 5(a). Therefore, when the planar shape of the camera hole CH or the sheet hole 240h has a shape such as a circular shape, an elliptical shape, or a square shape, the planar shape of the diffusion part 340 may also have a shape such as a circular shape, an elliptical shape, or a square shape depending on the planar shape of the camera hole CH or the sheet hole 240h.

As shown in FIG. 7(a), the diffusion part 340 may have unevenness including a concave shape or a convex shape directly formed on the front surface of the module light guide plate 310. Alternatively, as shown in FIG. 7(b), a diffusion film having unevenness including a concave shape or a convex shape may be attached to the front surface of the module light guide plate 310.

Specifically, as shown in FIG. 7(a), when the diffusion part 340 is directly formed on the front surface of the module light guide plate 310, the diffusion part 340 having unevenness may be provided on a partial area of the front surface of the module light guide plate 310. The diffusion part 340 may have unevenness with fine curvature for efficient diffusion of light. When the diffusion part 340 is directly formed on the front surface of the module light guide plate 310, the diffusion part 340 may be formed by any one of laser irradiation, printing, stamping, imprinting, and injection techniques.

As shown in FIG. 7(b), when the diffusion part 340 is provided as a diffusion film, the diffusion film may include a base film 340a attached to the module light guide plate 310 and a fine pattern layer 340b located on the base film 340a. The base film 340a may include transparent plastic or glass, and the fine pattern layer 340b may have unevenness with fine curvature or glass beads as diffusion particles to efficiently diffuse light.

As described above, the width W340 of the diffusion part 340 is formed to be larger than the width WCH of the camera hole CH or the sheet hole 240h and smaller than the width of the module light guide plate 310. Here, as shown in FIGS. 7(a) and 7(b), the diffusion part 340 may not be located in the edge area of the module light guide plate 310.

A haze value of the diffusion part 340 may be in a range from 25% to 35%, i.e., may be 25% or more and 35% or less. Accordingly, the quality of an image captured by the optical element 350 may be appropriately secured while the auxiliary light is diffused toward the camera hole CH by the diffusion part 340.

As haze increases, more light is scattered, resulting in an opaque or blurry appearance. Conversely, as haze decreases, more light may travel straight, resulting in a clear appearance. If the haze value of the diffusion part 340 is excessively high, the quality of an image captured by the optical element 350 configured to detect external light that is incident through the diffusion part 340 may deteriorate. On the other hand, if the haze value of the diffusion part 340 is excessively low, a degree of refraction and scattering of auxiliary light traveling inside the module light guide plate 310 may be reduced, and thus the amount of light diffused toward the camera hole CH may be relatively reduced.

FIGS. 8(a) to 8(d) are views showing examples of images captured by the optical element 350 depending on the haze values of the diffusion part 340. FIG. 8(a) shows a case in which the haze value of the diffusion part 340 is 0%, FIG. 8(b) shows a case in which the haze value of the diffusion part 340 is 90% or higher, FIG. 8(c) shows a case in which the haze value of the diffusion part 340 is 50%, and FIG. 8(d) shows a case in which the haze value of the diffusion part 340 is 30%.

As shown in FIG. 8(d), when the haze value of the diffusion part 340 is 30%, as compared with FIG. 8(a) showing the case in which the haze value of the diffusion part 340 is 0%, it can be seen that the quality of an image captured by the optical element 350 is reliably maintained without significant deterioration in image quality. However, in the cases of FIG. 8(b) and 8(c), it can be seen that the quality of an image captured by the optical element 350 significantly deteriorates.

Considering the above-described results, the haze value of the diffusion part 340 may be set to a value in a range from 25% to 35% in the present disclosure.

The module light sources 330 may be respectively located on the side surfaces of the module light guide plate 310 and may allow auxiliary light to be incident on the module light guide plate 310. The auxiliary light incident on the module light guide plate 310 from the module light source 330 may be reflected, refracted, and scattered by the selective transmission part 320 and the diffusion part 340 and then may be emitted toward the camera hole CH.

Each of the module light sources 330 may be a self-luminous element capable of generating and emitting light. For example, each of the module light sources 330 may include an LED. Each of the module light sources 330 may be the same element as that of the backlight light source 212. Each of the module light sources 330 may be connected to a corresponding one of module circuit boards 390 (refer to FIG. 4) each configured to control on/off of the module light source. Brightness of the auxiliary light generated from each of the module light sources 330 may be adjusted depending on a brightness level displayed in the hole area HA of the liquid crystal panel.

The module light sources 330 may be turned on/off, simultaneously. The module light sources 330 may be driven simultaneously with the backlight light source 212. For example, the liquid crystal panel 100 may generate an image using light emitted from the backlight light source element 210 and light emitted from the module light sources 330. That is, in the present disclosure, when the liquid crystal panel 100 generates an image, light may be supplied to the hole area HA of the liquid crystal panel 100 by the module light sources 330.

As shown in FIGS. 5(a) and 5(b), the module light sources 330 may be respectively located on the side surfaces of the module light guide plate 310, which face each other in the second direction D2, such that the module light sources face each other in the second direction D2. However, the present disclosure is not limited thereto, and for example, as shown in FIG. 9, the module light sources 330 may be respectively located on the side surfaces of the module light guide plate 310, which face each other in the first direction D1, such that the module light sources face each other in the first direction D1.

The optical element 350 may be located on the back surface of the selective transmission part 320 in a state of overlapping the camera hole CH or the sheet hole 240h. The optical element 350 may include an element capable of detecting external light, and may include a lens part 350a on which external light is incident and a body part 350b on which the lens part 350a is mounted.

The optical element 350 may include an infrared (IR) sensor. However, the present disclosure is not limited thereto, and the optical element 350 may include at least one of a motion sensor, an illuminance sensor, or an ultrasonic sensor.

The optical module 300 of the present disclosure may maximally reduce visibility of the optical element 350 in the hole area HA of the liquid crystal panel, and may improve image quality (FOS quality) characteristics of an image displayed on the liquid crystal panel.

For example, when the optical module 300 is provided with only the optical element 350, as shown in FIG. 10(a), when an image is displayed in the active area of the liquid crystal panel, the hole area HA appears dark. Accordingly, a dark portion may be visually recognized in the image of the liquid crystal panel, and the lens part and the body part of the optical element 350 may be visually recognized by a user through the hole area HA.

However, according to the present disclosure, when the optical module 300 is provided with the selective transmission part 320, light in the visible spectrum is reflected. Accordingly, as shown in FIG. 10(b), visibility of the optical element 350 in the hole area HA of the liquid crystal panel may be greatly reduced.

In addition, according to the present disclosure, when the optical module 300 is provided with the module light source 330, the module light guide plate 310, and the diffusion part 340, auxiliary light generated from the module light source 330 is diffused toward the camera hole CH. Accordingly, as shown in FIG. 10(c), a brightness difference between the active area and the hole area HA is maximally reduced, thereby removing a dark portion in which the hole area HA appears dark in FIG. 10(a). As a result, the present disclosure may improve image quality (FOS quality) characteristics of an image displayed on the liquid crystal panel.

As is apparent from the above description, a display apparatus according to one embodiment of the present disclosure includes an optical module including a selective transmission part, thereby maximally reducing visibility of an optical element in a hole area of a liquid crystal panel.

Additionally, a display apparatus according to one embodiment of the present disclosure includes an optical module including a module light guide plate and a diffusion part. Accordingly, when an image is displayed on a liquid crystal panel, a brightness difference between an active area and a hole area may be maximally reduced, thereby improving image quality (front of screen (FOS) quality) characteristics of the image displayed on the liquid crystal panel.

It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

What is claimed is:

1. A display apparatus, comprising:
a backlight unit comprising a backlight light guide plate, a backlight sheet having a sheet hole, and a backlight light source element configured to emit light to the backlight light guide plate;
a liquid crystal panel located on a front surface of the backlight unit; and
an optical module located on a back surface of the backlight unit and overlapped with the sheet hole,
wherein the optical module comprises:
a module light guide plate disposed on a back surface of the backlight light guide plate and overlapped with the sheet hole, the module light guide plate being configured to receive auxiliary light from a module light source located on a side surface of the module light guide plate and to allow the auxiliary light to pass through;
a diffusion part disposed on a front surface of the module light guide plate and overlapped with the sheet hole, the diffusion part being configured to diffuse the auxiliary light toward a front surface of the liquid crystal panel;
a selective transmission part disposed on a back surface of the module light guide plate and overlapped with the sheet hole, the selective transmission part being configured to, among external light incident through the sheet hole, reflect external light in a visible wavelength band and allow external light in an infrared wavelength band to pass through; and
an optical element disposed on a back surface of the selective transmission part and overlapped with the sheet hole.

2. The display apparatus according to claim 1, wherein the selective transmission part has a larger width than a width of the sheet hole and/or a smaller thickness than a thickness of the module light guide plate.

3. The display apparatus according to claim 1, wherein the selective transmission part has a same width as a width of the module light guide plate.

4. The display apparatus according to claim 1, wherein the selective transmission part comprises a dichroic layer.

5. The display apparatus according to claim 1, wherein the selective transmission part comprises a dielectric material.

6. The display apparatus according to claim 1, wherein the selective transmission part comprises at least one of silicon oxide (SiO₂), titanium oxide (TiO₂), or aluminum oxide (Al₂O₃).

7. The display apparatus according to claim 1, wherein the selective transmission part has a transmittance of 5% or less in a wavelength band ranging from 400 nm to 700 nm of external light and has a transmittance of 90% or more in a wavelength band ranging from 900 nm to 950 nm of external light.

8. The display apparatus according to claim 1, wherein the diffusion part has a width larger than a width of the sheet hole and smaller than a width of the module light guide plate and/or a planar shape corresponding to a planar shape of the sheet hole.

9. The display apparatus according to claim 1, wherein the diffusion part has a haze value in a range from 25% to 35%.

10. The display apparatus according to claim 1, wherein the diffusion part is provided on the module light guide plate by directly forming unevenness comprising a concave shape or a convex shape on the front surface of the module light guide plate or by attaching a film having unevenness comprising a concave shape or a convex shape to the front surface of the module light guide plate.

11. The display apparatus according to claim 1, wherein the module light guide plate comprises any one of glass, acrylic, polymethylmethacrylate (PMMA), and polycarbonate (PC).

12. The display apparatus according to claim 1, wherein the module light guide plate comprises a material identical to a material of the backlight light guide plate and/or has a smaller thickness than a thickness of the backlight light guide plate.

13. The display apparatus according to claim 1, wherein the optical element comprises an infrared (IR) sensor, and/or the module light source is configured to emit the auxiliary light in a visible spectrum.

14. The display apparatus according to claim 1, wherein the backlight unit further comprises a backlight reflector, the backlight reflector being located on the back surface of the backlight light guide plate and being configured to reflect light emitted through the back surface of the backlight light guide plate toward the liquid crystal panel.

15. The display apparatus according to claim 14, wherein the backlight sheet has a laminated structure in which a diffusion sheet, a prism sheet, and a dual brightness enhancement film are laminated.
